(19) United States
(12) Patent Application Publication
(10) Pub. No.: US 2026/0095826 A1
(43) Pub. Date: Apr. 2, 2026

(54) METHODS, APPARATUSES AND SYSTEMS RELATED TO LOWER LAYER TRIGGERED MOBILITY DUAL CONNECTION HANDOVER

(71) Applicant: InterDigital Patent Holdings, Inc., Wilmington, DE (US)

(72) Inventors: Brian Martin, Farnham (GB); Martino Freda, Laval (CA); Oumer Teyeb, Montreal (CA); Dylan Watts, Montreal (CA); Paul Marinier, Brossard (CA); Keiichi Kubota, Setagaya-Ku (JP); Umer Salim, Vallauris (FR)

(21) Appl. No.: 18/899,208

(22) Filed: Sep. 27, 2024

(51) Int. Cl. H04W 36/00; H04L 5/00

(52) U.S. Cl. CPC H04W 36/0085; H04L 5/0048; H04W 36/0058

(57) ABSTRACT

In an embodiment, a method implemented in a WTRU comprises receiving, from a source cell, a first message comprising information indicating a configuration including resources for measurement on RSs of the source and of a target cells; wherein resources for measurement on RSs contain a timing reference; receiving RSs from the source and from the target cells; performing a time difference measurement between source cell RSs and target cell RSs; on condition that the measured time difference is within a threshold amount from zero: transmitting, to the source cell, a second message comprising information indicating the measured time difference between the source and the target cell RSs; receiving, from the source cell, a third message comprising information indicating downlink scheduling resources on the target cell; and receiving, from the target cell, a fourth message comprising information indicating release of configuration associated with the source cell.

### FIELD OF THE INVENTION

The present disclosure is generally directed to methods and procedures related to lower layer triggered mobility dual connection handover. More particularly the present disclosure relates to methods, apparatuses and systems to perform L1/L2 based Dual Active Protocol Stack (DAPS)-like procedure, but without requiring a user equipment to maintain multiple “protocol stacks”.

### BACKGROUND

In new radio (NR), Dual Active Protocol Stack (DAPS) handover was defined to support zero millisecond (ms) handover interruption. While on paper, this has been achieved, in practise DAPS was never deployed in a real network primarily due to complexity on a user equipment (UE) side. As a result of no commercial availability, the standards for this feature were never developed to support dual connectivity, carrier aggregation, or any other mobility enhancement.

In addition, DAPS may suffer from throughput degradation during handover, for the following reasons:
(a) While maintaining two downlink link links: (i) intra frequency interference, (ii) in case of time division duplex (TDD), there is not enough uplink slots to send hybrid automatic repeat request (HARQ) acknowledgment (ACK), and downlink rate at source is reduced. Note that only one uplink is used for DAPS, and switches from source to target when random access channel (RACH) is completed on target.
(b) Before target channel quality index (CQI) is obtained: (i) target may start with low modulation and coding scheme (MCS) to guarantee the reliability, and slowly ramps up, (ii) channel state information (CSI) configuration of target may not be frequent enough (because the target configures less frequent resource as it does not know when the connection will start). Note that 3GPP Release 19 may introduce CSI acquisition before cell switch for lower layer triggered mobility (LTM), which could help address this if applied to DAPS too.

When source is released: throughput may drop significantly because DL data from source may be stopped and DL data at target may not have ramped up.

In document R1-167205 “UE-cell-center-like Design Principles and Tracking Signal Design”, Huawei, it is assumed that the co-ordination of multiple TRPs/cells can be done completely transparently to the UE. However, in document 6G RAN-key building blocks for new 6G radio access networks “, Ericsson, 15 May 2024, this may not be (e.g., completely) possible.

In order to support a more traditional cellular architecture, it is (e.g., usually) necessary to be able to identify individual transmission reception points (TRPs) or cells, in order to identify measurement results, reference signals, and so on.

There is a need to achieve Oms interruption using a simpler mechanism than DAPs for UE, based on LTM, and without/with limited throughput degradation during/after handover.

### SUMMARY

In an embodiment, a method, implemented in a wireless transmit/receive unit (WTRU) may comprise a step receiving, from a source cell, a first message comprising information indicating a handover configuration including resources for measurement on RSs of the source cell and of a target cell; wherein resources for measurement on RSs contain a timing reference. The method may comprise a step of receiving RSs from the source cell and from the target cell. The method may comprise a step of performing at least one time difference measurement between source cell RSs and target cell RSs. On condition that the at least one measured time difference is within a threshold amount from zero, the method ma comprise a step of transmitting, to the source cell, a second message comprising information indicating the measured time difference between the source cell RSs and the target cell RSs; a step of receiving, from the source cell, a third message comprising information indicating downlink scheduling resources on the target cell; and a step of receiving, from the target cell, a fourth message comprising information indicating release of configuration associated with the source cell.

The method may further comprise a step of performing at least one radio quality measurement on at least one target cell RS, wherein transmitting, to the source cell, the second message is on condition that the radio quality measurement satisfies a radio quality condition threshold. The method may further comprise a step wherein the second message further comprises information indicating result of the at least one radio quality measurement.

On condition that the at least one measured time difference is out of (e.g., above) a threshold amount from zero, the method may comprise a step of transmitting, to the source cell, a fifth message comprising information indicating the measured time difference between the source cell RSs and the target cell RSs; and a step of re-performing at least one time difference measurement between source cell RSs and target cell RSs.

On condition that the at least one measured time difference is within the threshold amount from zero, the method may further comprise a step of performing channel state information CSI acquisition for the target cell resources according to the measured time difference.

On condition that the at least one measured time difference is within the threshold amount from zero, the method may comprise a step of performing, beam refinement, for the target cell resources according to the measured time difference.

The handover configuration may include a subset of downlink measurement RS on the target for which to use for determining downlink reception time difference between source and target RSs, and/or wherein the handover configuration includes a subset of downlink measurement RS on the source for which to use for determining downlink reception time difference between source and target RSs.

The fourth message may be an indication on physical downlink control channel (PDCCH) from the target cell to release configuration associated with the source cell. The second message may be a CSI or MAC CE.

The method may comprise a step of receiving an indication on PDCCH from the source cell to start monitoring the PDCCH on the target cell.

In an embodiment, a wireless transmit/receive unit (WTRU) comprising a processor, a transmitter, a receiver and a memory, may be configured to receive, from a source cell, a first message comprising information indicating a handover configuration including resources for measurement on RSs of the source cell and of a target cell; wherein resources for measurement on RSs contain a timing reference. The WRU may be further configured to receive RSs from the source cell and from the target cell. The WTRU may be further configured to perform at least one time difference measurement between source cell RSs and target cell RSs. On condition that the at least one measured time difference is within a threshold amount from zero, the WTRU may be configured to: transmit, to the source cell, a second message comprising information indicating the measured time difference between the source cell RSs and the target cell RSs; receive, from the source cell, a third message comprising information indicating downlink scheduling resources on the target cell; and receive, from the target cell, a fourth message comprising information indicating release of configuration associated with the source cell.

### BRIEF DESCRIPTION OF THE DRAWINGS

A more detailed understanding may be from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a signalling diagram illustrating an example of a lower layer triggered mobility (LTM) procedure according to an embodiment;

FIG. 3 is a signalling diagram illustrating an example of a dual active protocol stack (DAPS) handover procedure according to an embodiment;

FIG. 4 is a block diagram illustrating an example of a LTM based make-before break procedure according to an embodiment; and

FIG. 5 is a flow chart diagram illustrating an example of a method, implemented in a WTRU, for an LTM cell switch using on downlink timing alignment according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A sign, symbol, or mark of forward slash ‘/’ is to be interpreted as ‘and/or’ unless particularly mentioned otherwise, where for example, ‘A/B’ may imply ‘A and/or B’.

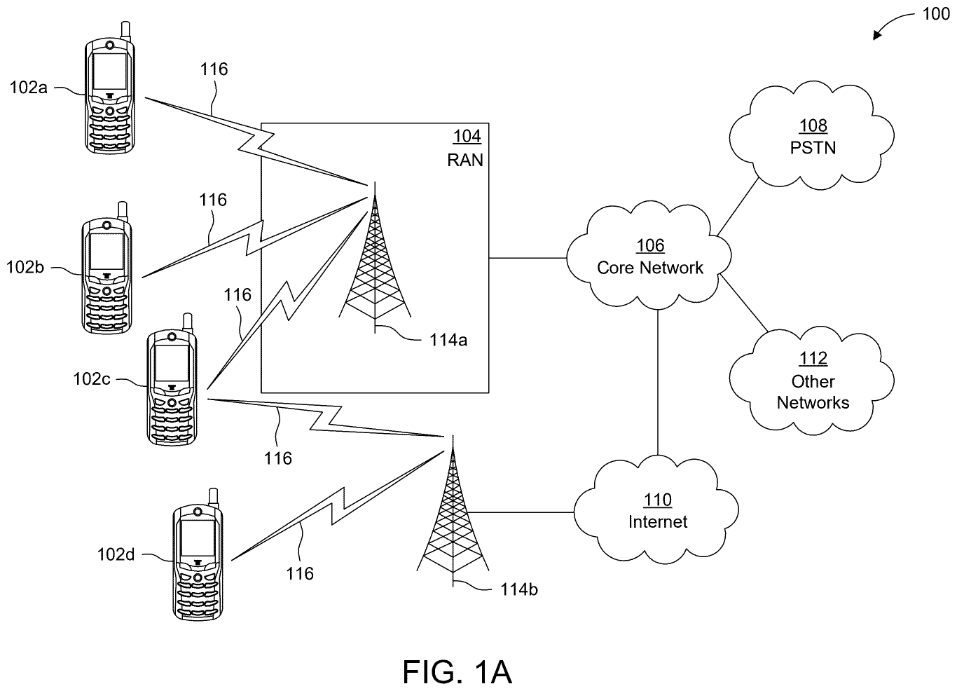

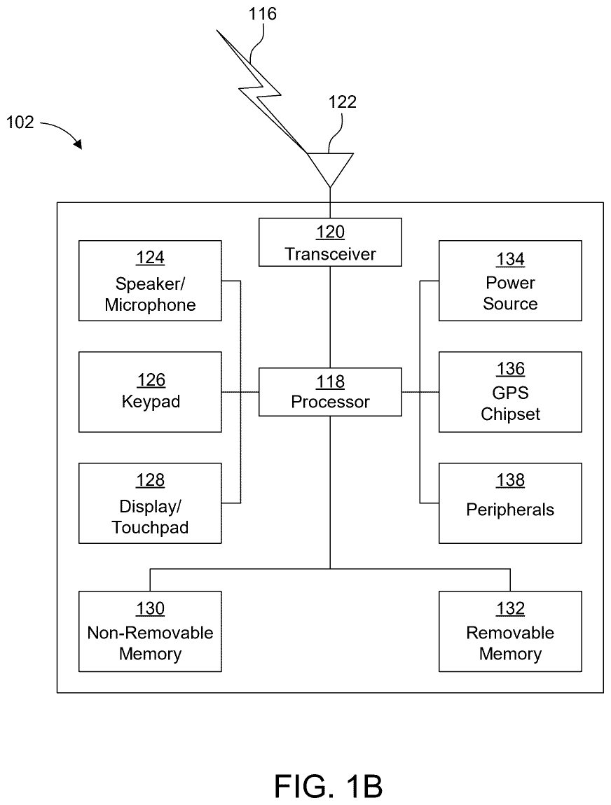

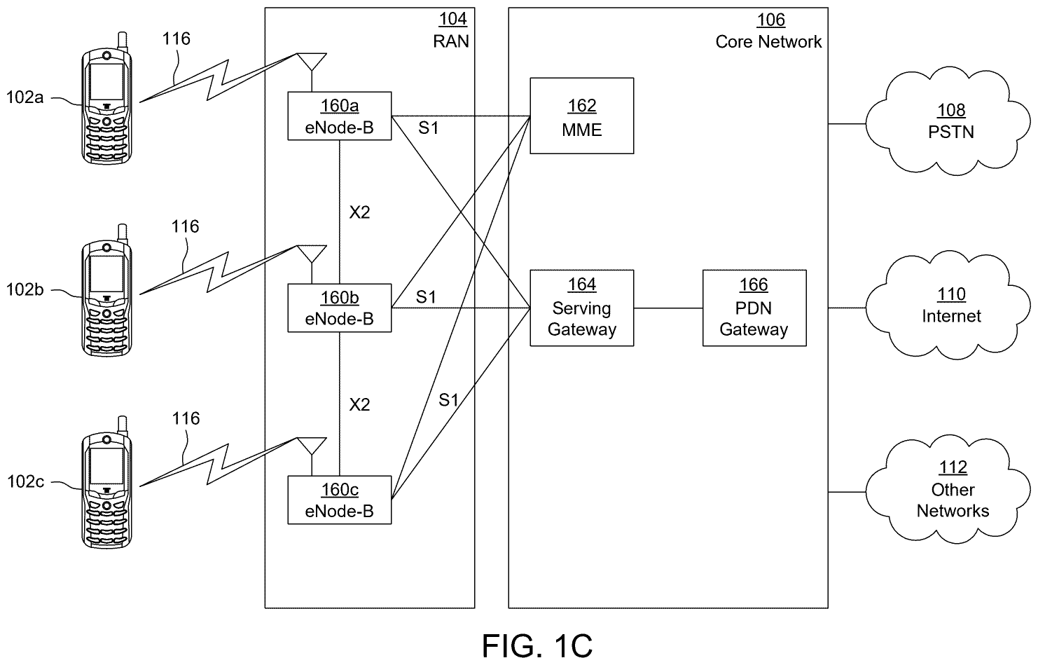

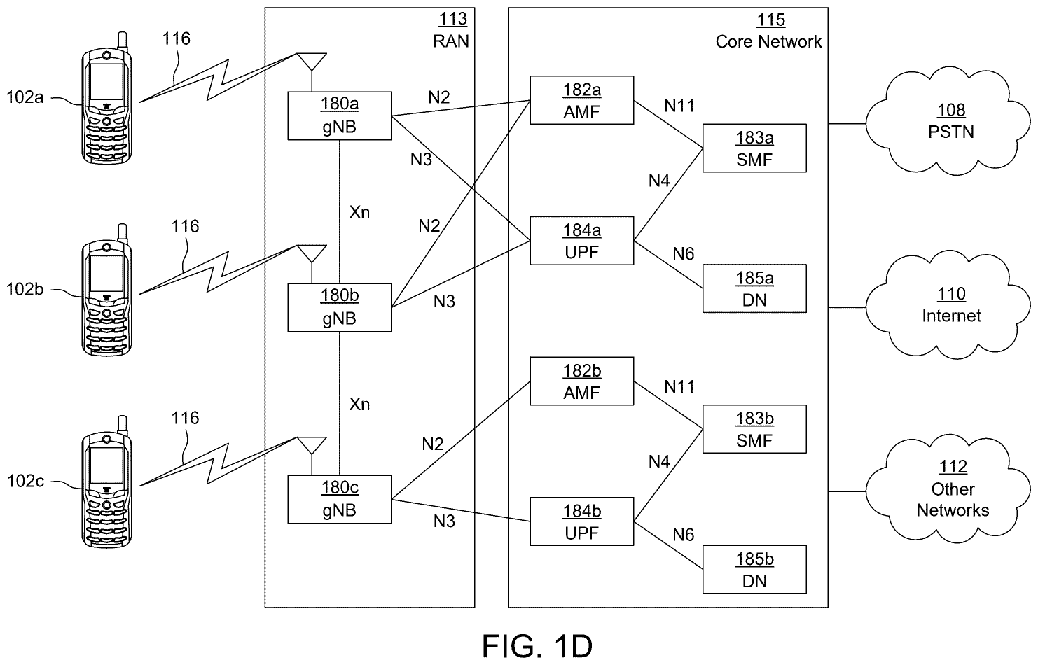

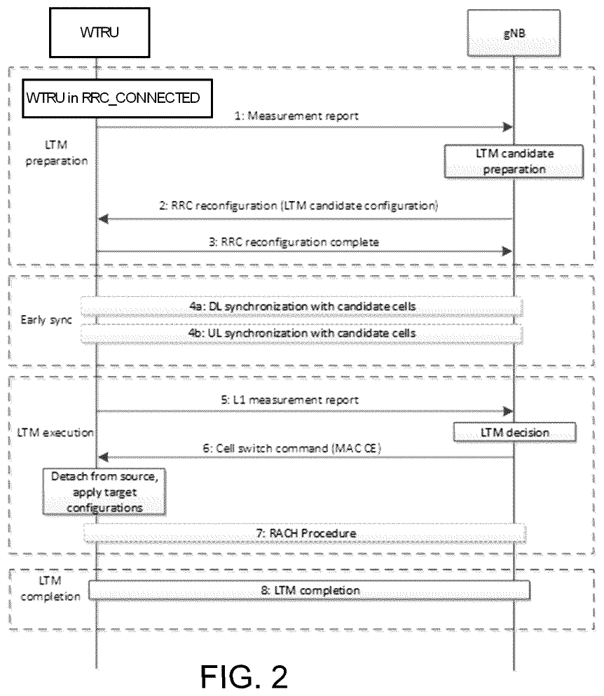

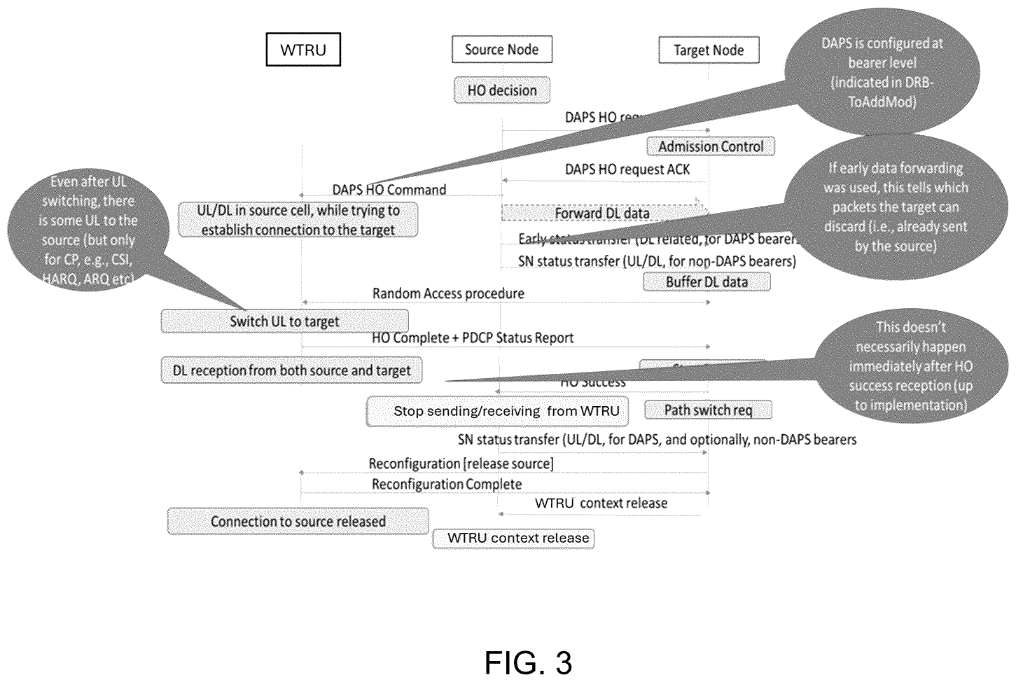

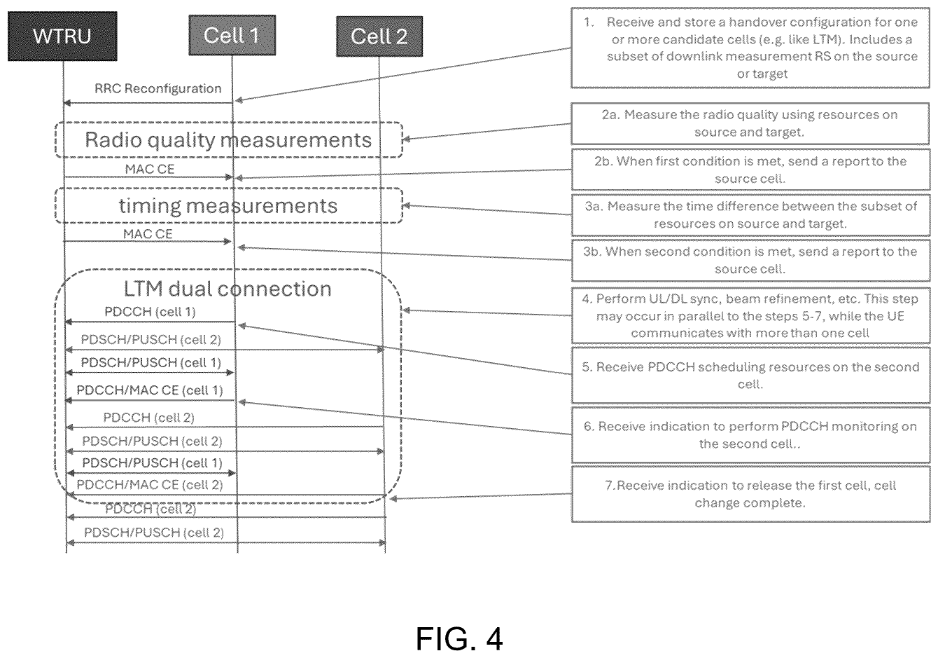

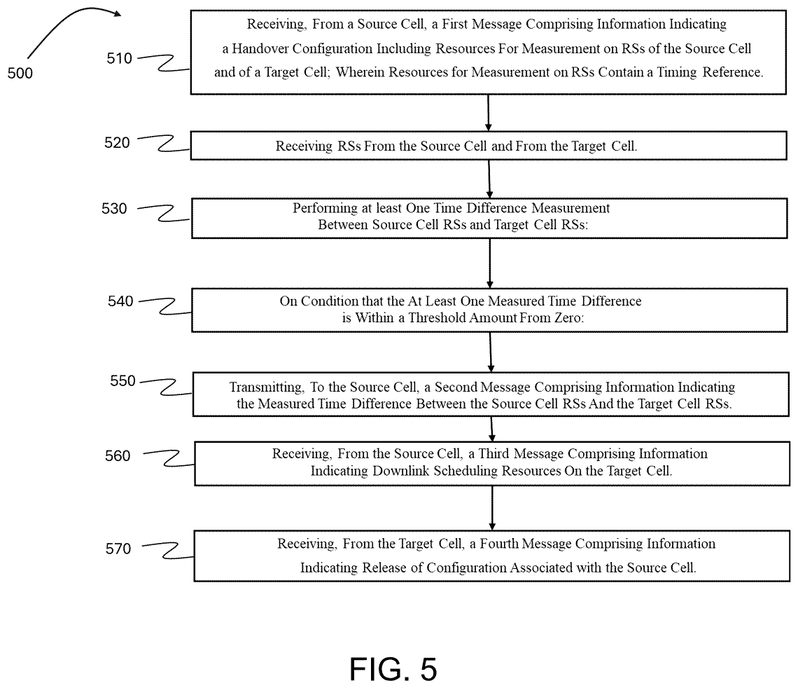

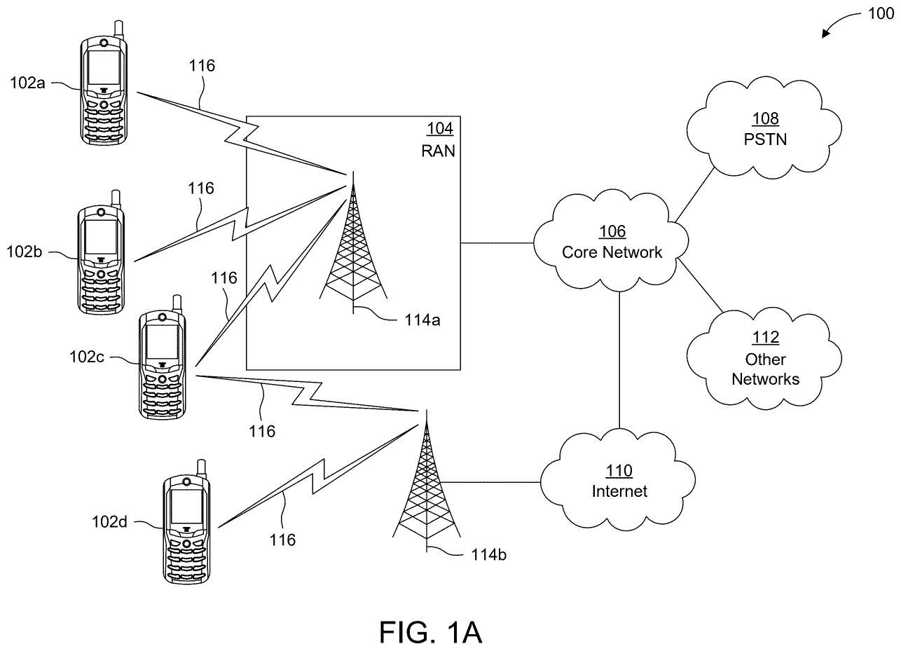

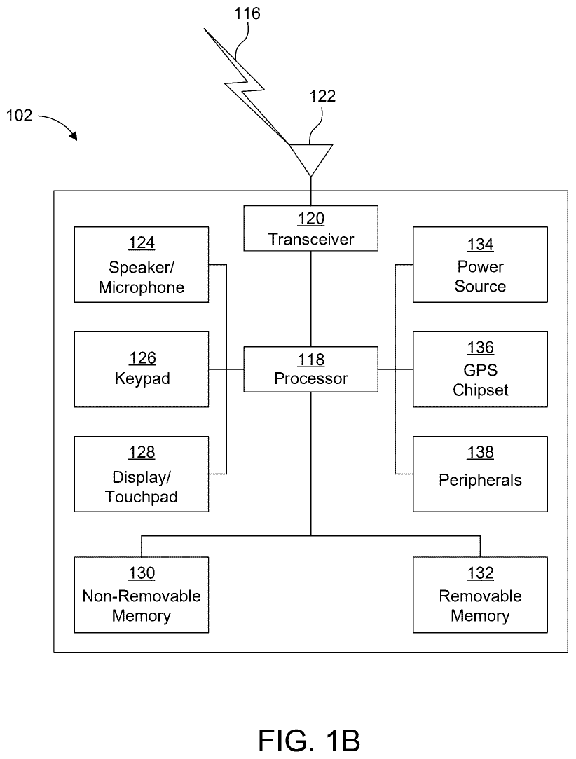

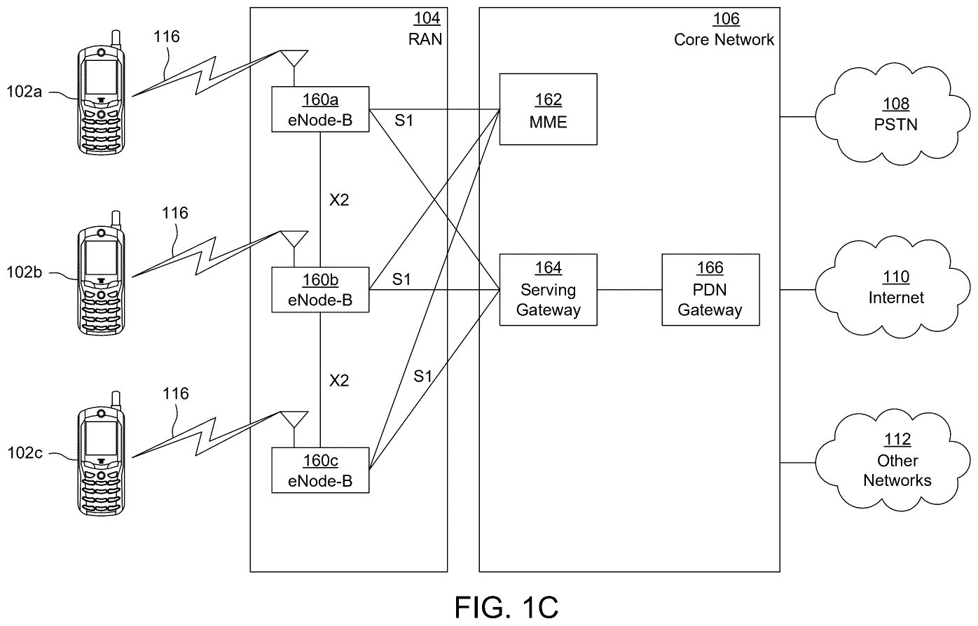

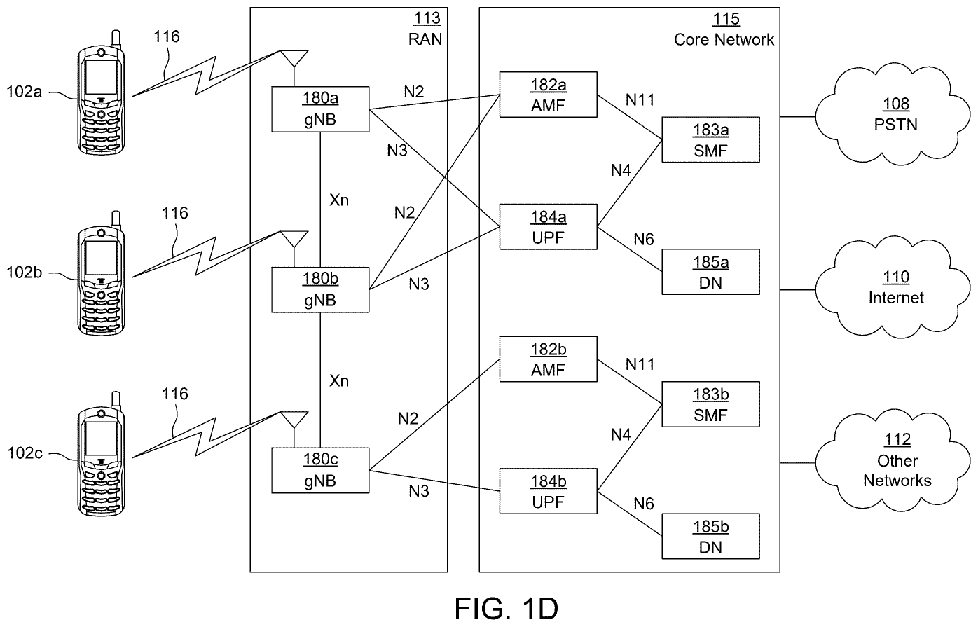

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (cNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), an universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11c DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signalling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications, such as machine-type communications devices in a macro coverage area. Machine-type communications devices may have certain capabilities, for example, limited capabilities including support for (e.g., only support for) certain and/or limited bandwidths. The machine-type communications devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, arc from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one access and mobility management function (AMF) 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signalling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (cMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device (e.g., a network node) may be directly coupled to another device for purposes of testing and/or may performing testing using over-the-air wireless communications.

The one or more emulation devices may perform the one or more, including all, functions while not being implemented/deployed as part of a network node (e.g., wired and/or wireless communication network). For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

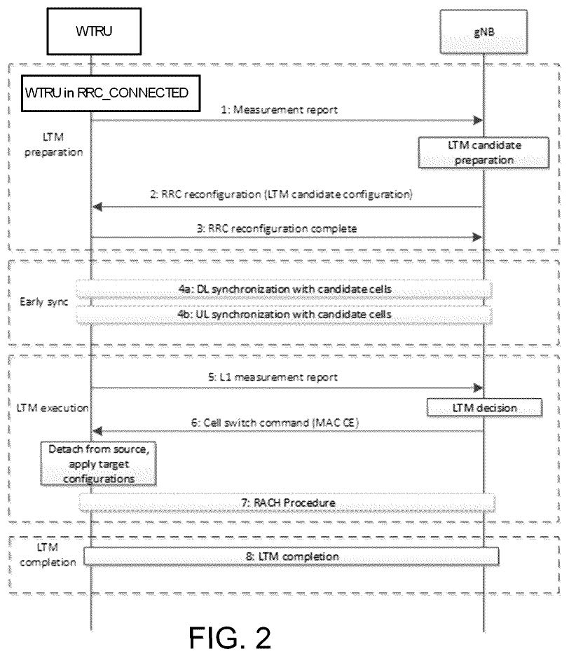

3GPP has introduced LTM in Rel-18 and agreed to a work item for enhancement in Rel-19. It may be expected that 6G mobility will use LTM procedures introduced to NR as a baseline. Referring to FIG. 2, an LTM procedure, according to document 3GPP TS 38.300 v18.0.0 section 9.2.3.5, is shown.

According to 3GPP Rel-16, a concept of Dual Active Protocol Stack (DAPS) Handover was introduced (for both LTE and NR) in order to reduce the interruption time during handover (HO) (which, for example, could range from 30 ms to 60 ms in LTE, depending on the handover scenario), thereby ensuring that the quality of highly delay sensitive services will not be degraded because of mobility.

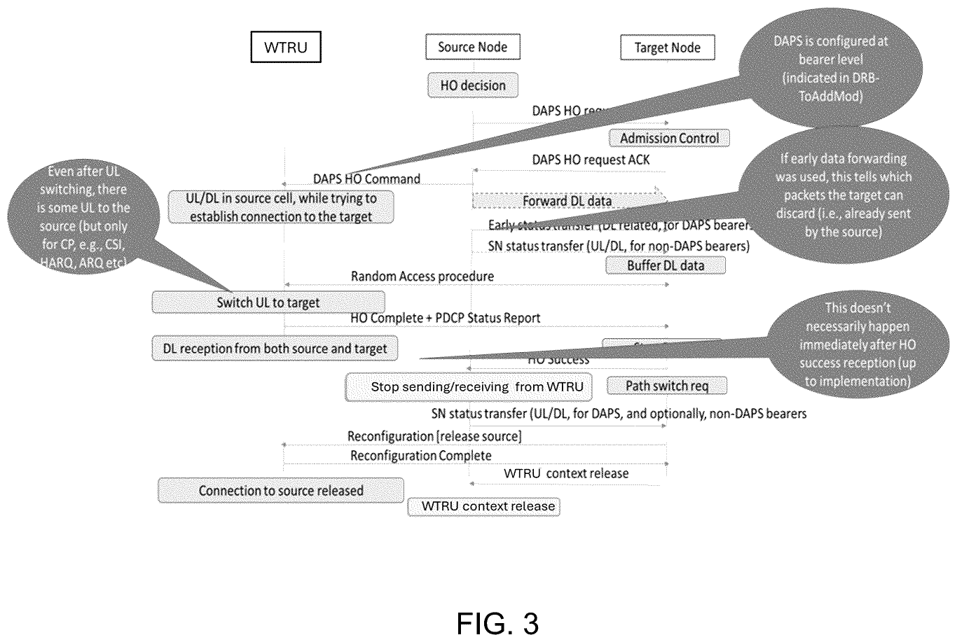

Referring to FIG. 3, a DAPS HO procedure is shown. A source node, upon deciding to perform a DAPS HO, may transmit a DAP HO request to a target node. A DAPS HO request may be a handover request that may include information regarding to which data radio bearers (DRBs) the DAPS HO is to be applied (i.e., it may be possible that for some DRBs normal HO can be applied). After performing admission control, the target node may transmit a response message with a HO request acknowledgement.

The source node may transmit a DAPS HO command to a wireless transmit/receive unit (WTRU), which may be an Radio Resource Control (RRC) Reconfiguration with reconfiguration WithSync that may (e.g., also) contain an indication regarding which DRBs are to be involved in DAPS HO. The source node may continue normal operation for uplink (UL) data (e.g., forwarding it to the core network) and for DL (e.g., transmitting it to the WTRU), but may also start forwarding the DL data towards the target.

Once the WTRU has managed to perform random access (RA) with the target node, UL data transmission may be switched to the target, but DL reception may be (e.g., still) performed from the source. The WTRU may transmit a HO complete, which is an RRC Reconfiguration Complete message, to the target, including a Packet Data Convergence Protocol (PDCP) status report for those DRBs that were configured for DAPS HO. The target node may start sending the buffered DL data to the WTRU, using the status information provided by the WTRU to avoid the transmission of duplicate packets (e.g., packets forwarded from the source but now indicated to have been received by the WTRU).

The target node may indicate the success of the handover to the source node, after which the source may stop transmitting and receiving data to/from the WTRU. The target node may (e.g., also) initiate path switch towards the core, so that new DL data will be sent to the target instead of the source. The target node may indicate to the WTRU the DAPS HO is finalized by transmitting an RRC Reconfiguration message that contains a daps-SourceRelease indicator, upon which the WTRU may release the connection to the source. The target may (e.g., also) transmit a context release message to the source, so that all the WTRU context at the source node may got released.

As indicated above, DAPS handover may be configured on a DRB level (e.g., normal PDCP/RLC/MAC procedures applied for the bearers not configured for DAPS handover) and a handover may be referred to as a DAPS handover if at least one bearer is configured for DAPS. The handover mechanism triggered by RRC may require the WTRU at least to reset the Medium Access Control (MAC) entity and re-establish radio link control (RLC), except for DAPS handover, where upon reception of the handover command, the WTRU may: (i) create a MAC entity for the target; (ii) establish the RLC entity and an associated logical channel for the target for each DRB configured with DAPS (hence the name dual protocol stack); (iii) for the DRB configured with DAPS, reconfigure the PDCP entity with separate security and ROHC functions for source and target and associate them with the RLC entities configured by the source and the target; and retain the rest of the source node configurations until instructed to release the source node.

Since a mobile terminal will receive user data simultaneously from both the source node and target cell, the PDCP layer may be reconfigured to a common PDCP entity for the source node and target user plane protocol stacks. To secure in-sequence delivery of user data, PDCP Sequence Number (SN) continuation may be maintained throughout the handover procedure. For that reason, a common (for source and target) re-ordering and duplication function may be provided in the single PDCP entity. Ciphering/deciphering and header compression/decompression may be handled separately in the common PDCP entity, depending on the origin/destination of the DL/UL packet.

According to document “6G RAN-key building blocks for new 6G radio access networks”, Ericsson, 15 May 2024, “Distributed MIMO where the antenna elements are spread out (in academic literature this is often, somewhat incorrectly, referred to as “cell-free MIMO”). This is primarily of interest for denser deployments. By exploiting transmissions from multiple radio sites, a high degree of reliability can be achieved along with high data rates and interruption-free mobility.” “Scheduling strategies can also be refined. Ideally, the transmission points and frequency resources in an area should be seen as a single, unified resource over which the scheduler operates with the target of always assigning the best combination of frequencies and transmission points to the transmissions. Although this to a large extent is an implementation aspect, the signaling mechanisms defined for 6G should be designed with this in mind. Avoiding synchronous timing dependencies between the user equipment (UE) and network and a reduction in scheduling constraints are prerequisites for such implementations.” “Having one scheduler handling multiple transmission points and carriers also enables various forms of coordination and can better take the interference situation into account. Efficient interference coordination, enabled by a more centralized type of scheduling when feasible, is one of the more promising ways to improve performance on a given site grid. AI/ML is also an interesting tool to investigate in this area.”

According to document R1-167205 “UE-cell-center-like Design Principles and Tracking Signal Design”, Huawei, “Targeting to support seamless mobility, as a UE moves among the TRPs within a hypercell, there is no L3 mobility (i.e., handover or cell selection/reselection) and no mobility interruption, which is key performance requirements in NR; while as the UE moves across different hypercells, these TRPs that belong to different hypercells can facilitate “make before break” mechanism to minimize mobility interruptions. The group of TRPs (e.g. multiple macros and picos) operate together and look like one to the UE, i.e., the actual TRPs belonging to a hypercell are transparent to the UEs. On the other hand, network can configure a subset of TRPs within the hypercell to transmit synchronization signals and essential system information. The hypercell ID is used for synchronization purposes and entry to NR system, which impacts synchronization signals and the channel design of carrying essential system information. While the system design needs to study the UE operations with minimized dependencies to hypercell ID, in order to eliminate the cell limitation.”

According to the described embodiments herein, “perform mobility procedure” or “perform mobility” may refer to performing any/all of the steps described in FIG. 2 for NR, or similar procedures for 6G. Specifically, early synchronization in DL and/or UL to one or more of the candidate cells, performing L1 measurements and reporting on one or more of the candidate cells, switching (i.e. performing handover) between candidate cells (“Perform LTM” can mean that the WTRU may move/switch between multiple candidate cells during the procedure). This may also be used to refer to the process of adding a cell (e.g., a second cell) to a WTRU connection configuration (e.g. instead of switching from one cell to another, adding a second cell in addition to the first) or may be used to refer to releasing a cell (e.g., once the WTRU has more than one cells configured, releasing one or more of those cells)?

A one or more candidate cell sets may be groups of more than one RRC configuration corresponding to a handover configuration for one or more candidate SpCells and optionally SCells. This may be modelled or received as one or more complete RRC reconfiguration messages, one or more cell group configurations, or one or more cell configurations. Each of the candidate cell configurations may include a candidate configuration identifier, and each of the candidate cell groups may include a candidate cell group identifier. If the grouping is performed at RRC, the switching between different sets of candidate cells may include updating the serving cell indexes or candidate configuration indexes which are used in L1 and MAC signalling to refer to specific indexes (for example a MAC CE triggering the reconfiguration may include a candidate configuration index informing the WTRU which cell to perform the reconfiguration to).

The one or more candidate cell groups may be configured as a single list or group of candidate cell configurations at RRC. The grouping may occur at the early sync or LTM execution phase rather than the configuration phase-what this means is that the candidate cell set may be considered as a single group in terms of an RRC configuration list or group, while the cells selected for performing early sync, L1 measurements, and LTM execution depend on a further grouping into multiple subsets of the overall candidate cell list. In other words the grouping itself may not be modelled at RRC using candidate configuration identifiers, but the grouping is executed as part of the early sync or the LTM execution procedure.

Throughout this disclosure, when referring to an LTM candidate configuration, this may apply to any type of preconfigured cell information. For example, a WTRU may be configured with one or more conditional reconfigurations such as conditional handover (CHO), conditional PSCell addition (CPA) or conditional PSCell change (CPC) which are valid before and/or after a cell change or cell addition or cell release, or valid in certain cells.

Synchronization Signal Block (SSB) or SS/PBCH block, may include at least one of the following: Primary Synchronization Signal (PSS), Secondary Synchronization Signal (SSS), physical broadcast channel (PBCH) (e.g., Data, MIB) and PBCH (e.g., DeModulation Reference Signal (DMRS)). The SSBs may be transmitted by a network (NW) node (e.g., base station, TRP, relay node, RIS unit) in different directions as beams. The number of SSB beams in an SSB burst set, which may be transmitted periodically within an interval (e.g. 5 ms) may depend on the carrier frequency. For example, an SSB burst may contain four SSBs for FRI (<3 GHZ), 8 SSBs for FR1 (3 to 6 GHZ) and 64 SSBs for FR2. Certain SSBs may be transmitted as on-demand SSBs (OD-SSBs), which may possibly consist of a subset of SSBs in a burst. Such OD-SSBs may be transmitted aperiodically, semi-persistently, or periodically with certain periodicity. The transmission of such OD-SSBs may be triggered by the NW node or WTRU (e.g., via transmission of an UL wake up signal (WUS)). Some SSBs may include slim/lean SSBs, which may comprise of PSS only, PSS and SSS-only, PBCH or a subset of MIB-only, for example.

Channel state information reference signal (CSI-RS), which may include at least one of the following: CSI-RS resource set (ID), CSI-RS resource (ID/index), resource mapping, power control offset values (e.g. with respect to Physical Downlink Shared Channel (PDSCH), SSB), scrambling ID, periodicity, offset and QCL info. CSI-RS may be transmitted in DL by a NW node as CSI-RS beams, via different resource types including periodic, semi-persistent and aperiodic

Channel state information (CSI), may include at least one of the following: channel quality index (CQI), rank indicator (RI), precoding matrix index (PMI), an L1 channel measurement (e.g., reference signal received power (RSRP) such as L1-RSRP, or SINR), CSI-RS resource indicator (CRI), SS/PBCH block resource indicator (SSBRI), layer indicator (L1) and/or any other measurement quantity measured by a WTRU from the configured CSI-RS or SS/PBCH (SSB) block.

Any conditions relating to a state of the radio/channel, which may be determined by a WTRU from: a WTRU measurement (e.g., L1/SINR/RSRP, CQI/MCS, channel occupancy, RSSI, power headroom, exposure headroom), L3/mobility-based measurements (e.g. RSRP, Reference Signal Received Quality (RSRQ), s-measure), an RLM state, and/or channel availability in unlicensed spectrum (e.g. whether the channel is occupied based on determination of an LBT procedure or whether the channel is deemed to have experienced a consistent LBT failure).

An L1 measurement may consist of a measurement of RSRP, RSRP, RSSI, etc, performed by a WTRU of a cell, beam, set of cells, or set of beams. Said L1 measurement may be similar to L3 measurements reported in radio resource management (RRM), with differences in the filtering, reference signals measured, reporting mechanisms, etc.

Measurements may refer to L1 measurements for LTM. However, various embodiments below may apply also to RRM/L3 measurements, as well as other measurements (e.g., measurements of speed, location, height, traffic, etc).

LTM cell switch may refer to L1/2 triggered mobility whereby a preconfigured RRC configuration may be applied when a WTRU receives an indication using MAC CE or when a certain condition is met at the WTRU. However, various embodiments below may also apply to an RRC reconfiguration, an RRC conditional reconfiguration, as well as any other type of mobility procedure.

In various embodiments below, the terms, channels, and protocol design for 5G NR are assumed, however it should be understood that the various embodiments below apply equally to any cellular network such as a 6G 3GPP system, which may use different definitions for channels, signals, and so on. In the context of a 6G or future generation wireless network, some functions may or may not be necessary, depending on the system architecture, protocol design, and physical channel design, however it is assumed that a system may operate using the general principle that configurations are provided by an upper (e.g. RRC) layer which apply to multiple target cells, beam, or TRPs and the lower layer (e.g. MAC, L1) controls switching between the configurations.

The various embodiments herein are described in terms of radio access technology (RAT) mobility between cells in 5G NR and/or a new radio access technology to be defined for 6G communications. In various embodiments below, the term “6G NR” may refer to this RAT, however as the naming is yet to be defined this may be used interchangeably with any other term used to describe the 6G radio access technology. Although various embodiments refer to interworking within or between 5G NR and 6G NR, the various embodiments may similarly be applied to mobility between or within any RATs whereby at least one of the RATs uses an LTM or similar mobility procedure, for example LTE and 6G NR, LTE and 5G NR, and so on.

The various embodiments below may enable devices to perform mobility between different radio access technologies (RATs) or different cells in the same RAT, for example between standalone 6G carriers and 5G and/or 6G MRSS carriers. Where candidate cells, target cells, measurements, and so on, are described, this may refer to any beam, cell, physical resource, measurement, or procedure, on a RAT. For example, to “perform LTM”, may mean to “perform LTM from 5G to 6G” or it may mean to perform LTM from a 6G cell to another 6G cell.

A gNB (e.g. a centralized unit (CU) in case of CU/Distributed unit (DU) split architecture—note: RRC resides in CU) may configure potential LTM candidates using RRC signalling. In an embodiment a WTRU may receive a LTM candidate configurations using an RRC Reconfiguration message, for example during the “LTM preparation” phase shown in FIG. 2. The WTRU may store the LTM candidate configurations to later apply upon receiving an indication using L1/2 signalling (e.g., MAC CE) to perform a cell switch, for example in the “LTM execution” phase shown in FIG. 2.

In an embodiment, a configuration of potential LTM candidates may include candidate sets, for example a first set which may e.g. be suitable for a first path (for example, a WTRU may turn left and may take first road) and a second set which may be suitable for a second path (e.g., a WTRU may turn right and may take second road)

In one solution, some or all of the candidate set information is broadcast in system information, and the UE enables the pre-configuration of these broadcast configurations upon receiving an indication in dedicated signalling (E.g. RRC Reconfiguration) which refers to the broadcast one or more configurations (E.g. using an index or identifier)

In an embodiment, the configuration may include all or a subset of the potential cells in a specific area (for example all cells belonging to a CU with which the WTRU may be currently connected or cells within a particular geographical area). These cells may not yet have been detected or measured by the WTRU, but may be configured in advance. In an embodiment, after the initial configuration of LTM candidate configurations, the WTRU may receive an update to the configuration to modify, add, remove, or replace any part of the LTM candidate configurations.

In an embodiment, the WTRU may receive an indication to enable or disable some or all of the LTM configurations. For example, if it is predicted that the WTRU mobility would be better handled using L3 (e.g., RRC measurement report, RRC reconfiguration, conditional reconfiguration) then LTM may be disabled, and on the other hand if it is predicted that LTM would better suit the WTRU mobility then LTM may be enabled (e.g. a previously configured and disabled LTM configuration may be re-enabled).

In an embodiment, the configuration may be based on a prediction model internal to, and determined by, the network (e.g., gNB). This prediction may, for example, be based on what it (the NW prediction model) determines to be the WTRUs most likely paths.

In various embodiments, the candidate cell configurations may contain all or part of the information necessary to complete a reconfiguration (e.g. handover) to the candidate cell, such as channel configurations (e.g. PRACH, DPCCH, DPSCH), CORESET, BWP, security parameters, L2 parameters (e.g., MAC, RLC, PDCP), radio bearer configurations, and so on.

In various embodiments, the WTRU may be configured with a list of measurement resources and/or downlink reference signals on which to perform measurements. In various embodiments, an indication may be received to configure the WTRU to perform timing measurements on certain resources. For example, the WTRU may receive an indication that measurement resources with specific IDs or time-frequency location within a resource grid are to be measured, reported, or compared with certain other resources belonging to a different cell or TRP. These resources may represent a subset of the overall measurement resources corresponding to a particular cell, for example such that radio quality measurements may be performed on all of the resources, while timing measurements are performed on the subset of resources. This may, for example, enable the network to adjust the timing of the subset of resources, while keeping a default timing for resources which are not in the configured subset. In various embodiments, the configuration of the subset of resources may be implicit, for example based on a pre-defined relationship with any of the other physical characteristics of the cell. For example, a cell with a certain bandwidth, subcarrier spacing, Physical Cell Identity (PCI), or numerology may be configured such that the subset of resources on which to perform timing measurements can be determined using a predefined relationship or table specified in the standards.

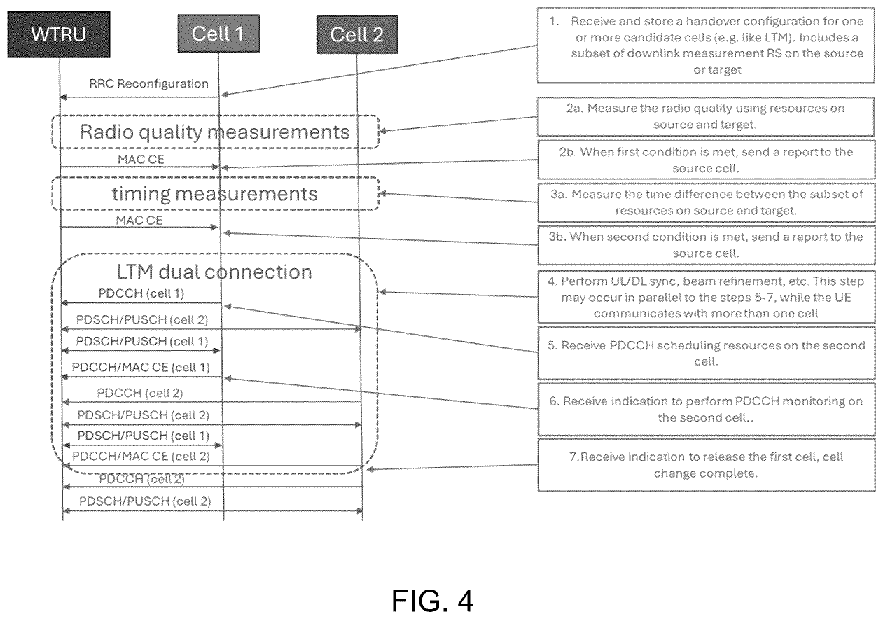

Execution trigger herein may refer to a condition for performing LTM (e.g., a conditional handover trigger or measurement report trigger), or for adding or releasing a source or target cell to the connection, which is either configured or indicated by the network to the WTRU, or estimated/determined by the WTRU. A trigger may be received to change the PDCCH which the WTRU monitors for scheduling from a first cell to a second cell, or the trigger may add a PDCCH from a second cell (so that the WTRU may monitor more than one Physical Downlink Control Channel (PDCCH)). The trigger may indicate a L1 change only, and a separate trigger may be used to change the upper layer configuration. For example, the WTRU may receive a PDCCH from a first cell indicating data (e.g., PDSCH) resources on a second cell. The WTRU may receive an indication (e.g., PDCCH or MAC CE) to start monitoring PDCCH on a second cell. The WTRU may or may not apply an upper layer configuration for the second cell (so for example, the first cell may continue to handle upper layer protocols such as MAC, RLC, PDCP, RRC while the second cell may perform scheduling at Layer 1). The WTRU may receive an explicit signal to change the upper layer configuration, or this may occur as part of any of the steps described herein, for example, when PDCCH monitoring on the second cell starts, or when the first cell is released, upon receiving an explicit command from the network, upon detecting a certain condition is met, or at any time during the “LTM dual connection” phase indicated in FIG. 4.

A trigger may be based on time, for example, absolute or relative time measured time at WTRU, single frequency networks (SFN), subframe number, and difference in timing between a source and a target cell.

A trigger may be based on radio quality measurement or predicted radio quality one or more of the serving cells or target cells. For example, RSRP (beam or cell), RSRQ (beam or cell), cri-RI-PMI-CQI (CSI-RS Resource Indicator-Rank Indicator-Precoding Matrix Indicator-Channel Quality Indicator), cri-RI-il, cri-RI-il-CQI, cri-RI-CQI, cri-RSRP, ssb-Index-RSRP, or cri-RI-L1-PMI-CQI.

A trigger may be based on position, for example, an area (e.g., defined by reference point and radius) or range of co-ordinates, or a distance threshold from a reference location.

A trigger may be based on any L3 measurement event, for example, event A1 (Serving becomes better than threshold), event A2 (Serving becomes worse than threshold), event A3 (Neighbor becomes offset better than SpCell), event A4 (Neighbor becomes better than threshold), event A5 (SpCell becomes worse than threshold1 and neighbor becomes better than threshold2), event A6 (Neighbour becomes offset better than SCell), event B1 (Inter RAT neighbour becomes better than threshold), or event B2 (PCell becomes worse than threshold1 and inter RAT neighbor becomes better than threshold2)

A trigger may be based on any L1 measurement event or condition, for example any event defined which utilizes L1 beam measurements to evaluate whether a criteria or condition is met. For example, event LTM1: Beam of serving cell becomes better than absolute threshold, event LTM2: Beam of serving cell becomes worse than absolute threshold, event LTM3: Beam of candidate cell becomes amount of offset better than beam of serving cell, event LTM4: Beam of candidate cell becomes better than absolute threshold, event LTM5: Beam of serving cell becomes worse than absolute threshold1 and beam of candidate cell becomes better than another absolute threshold2.

A trigger may be based on any time or location based condition, for example: time measured at WTRU is within a duration from threshold, distance between WTRU and referenceLocation1 is above threshold1 and distance between WTRU and referenceLocation2 is below threshold2, distance between WTRU and the serving cell moving reference location is above threshold1 and distance between WTRU and a moving reference location is below threshold2.

A trigger may be based on any combination of L3, L1, time, location-based conditions or events. For example, time measured at WTRU is within a duration from threshold and beam of candidate cell becomes better than absolute threshold, distance between WTRU and referenceLocation1 is above threshold1 and distance between WTRU and referenceLocation2 is below threshold2 and beam of candidate cell becomes amount of offset better than beam of serving cell, or distance between WTRU and the serving cell moving reference location is above threshold1 and distance between WTRU and a moving reference location is below threshold2 and beam of serving cell becomes worse than absolute threshold1 and beam of candidate cell becomes better than another absolute threshold2.

A trigger may be based on any predicted event, for example using any of the measurement quantities previously listed under “Measured or predicted CSI information”

A trigger may be based on an explicit indication from the network. For example, the WTRU may enable CSI reporting based on an explicit indication (e.g. a MAC CE) received from the network, then execute LTM cell switch upon receiving a second MAC CE from the network.

A trigger may be based on a measured, predicted, or estimated throughput, error rate, buffer status, data amount, or QoS parameter.

A trigger may be based on an evaluation metric, for example a time-to-trigger, a hysteresis, offset (e.g. a radio quality measurement offset), a measurement filtering configuration.

The trigger may include one or more conditions under which the WTRU is allowed to perform any action related to LTM. For example, the WTRU may perform one or more of the following procedures.
Procedure (i): Early TA acquisition. (a) A WTRU may trigger a RACH to a target LTM cell. WTRU may receive a timing advance (TA) value in a random-access response (RAR). RAR may come from target cell, or via source cell. WTRU may receive a TA value in a MAC CE triggering the cell switch. WTRU may perform power ramping and preamble retransmission on the target if a RAR/MAC CE is not received. (b) A WTRU may acquire a TA value of a candidate LTM cell by measurement, and trigger when complete. The WTRU may support and be configured with WTRU-based TA measurement, whereby the WTRU may acquire the TA value(s) of the candidate cell(s) by measurement.
Procedure (ii): Switching off CSI reporting. (a) The WTRU may be allowed to, or required to, switch off CSI reporting in order to reduce reporting overhead in the uplink. (b) The CSI reporting may be reduced rather than switched off. For example, reduced number of cells or beams reporting, or a reduced frequency of reporting. (c) The WTRU may resume CSI reporting when the condition is no longer met.
Procedure (iii): Switching on or updating the CSI reporting configuration. For example, the WTRU may be required to perform and report CSI measurements on one or a subset of LTM candidate cells during the window.
Procedure (iv): Performing LTM cell switch. Conditions or criteria under which the WTRU is allowed to trigger LTM cell switch.
Procedure (v): Monitoring PDCCH on a target cell. The WTRU may be configured to monitor on a target cell for a DCI scheduling PDSCH or indicating one or more actions on the target cell, for example to initiate the cell switch procedure.
Procedure (vi): Performing BFR or RLM on a target cell. The WTRU may be configured to monitor BFD (beam failure detection) resources on a target cell, or perform RLM (radio link monitoring) on a target cell during the window.
Procedure (vii): Activating or deactivating certain SCells. The WTRU may be configured with one or more specific SCells which should be active or not active during the window.
Procedure (viii): Adding or releasing certain PCells. For example, the WTRU may connect to a new PCell before releasing the existing one.
Procedure (ix): Adding or releasing certain physical layer configurations. For example, the WTRU may connect to a physical channel configuration associated with a new Cell, while maintaining a physical channel configuration associated with the current cell, without changing the upper layer configuration associated with the current cell. In other words, the WTRU may be configured with a new physical channel which is provided by a second cell, but as part of the current cell configuration and without changing the configuration to the new cell configuration.

The WTRU may perform beam refinement on a target cell before or during a handover or before the WTRU accesses the target cell, such that a WTRU may first perform measurement of SSB resources, then may select a subset of CSI-RS resources to measure based on the SSB measurements (e.g., based on the best SSB measured). Then, the WTRU may perform measurements on the selected subset of CSI-RS resource and may determine a best CSI-RS resource. The selected best CSI-RS resource may be indicated before a handover takes place (e.g. to a source cell), or upon initial access (e.g. to a target cell), rather than performing the beam refinement only after a connection to a target cell is completed. In various embodiments, the network may indicate to the WTRU to start monitoring (e.g., additionally monitoring) a target cell before the source cell connection has been released and the WTRU may perform beam refinement on the target cell before the source cell has been released.

The WTRU may report the measurements of the subset of CSI-RS resources using CSI reporting on physical uplink control channel (PUCCH) to the source cell and/or the target cell. The report may alternatively be transmitted using a MAC CE or an RRC measurement report, or any other type of uplink signaling. The report may contain one or more of: RSRP (beam or cell), RSRQ (beam or cell), cri-RI-PMI-CQI, cri-RI-il, cri-RI-il-CQI, cri-RI-CQI, cri-RSRP, ssb-Index-RSRP, and cri-RI-L1-PMI-CQI

The WTRU may determine, based on a trigger a subset of CSI-RS to measure. For example, the WTRU may determine based on a pre-configured association (e.g., configured by RRC) between SSB and CSI-RS resources. The WTRU may determine based on an indication of an SSB or determining a best SSB from performed SSB measurements.

A subset of CSI-RS may be indicated explicitly in a random access response (e.g., using a pointer to one of multiple subsets) or may be indicated implicitly (e.g., the WTRU may enable a subset of CSI-RS depending on a reported or indicated SSB when the RAR is received). The WTRU may alternatively enable the subset of CSI-RS measurements when the UE receives a PDCCH order triggering early TA acquisition, while the RAR or MAC CE containing a TA in response to the PRACH preamble transmission for TA acquisition activates the configured grant.

The CSI-RS measurements may be configured temporarily. For example, the WTRU may activate CSI-RS measurements for a certain time period, or a certain number of reports, which may be configured or predefined. The WTRU may report CSI-RS measurements for the source and/or the target cell during the time for which both source and target cell signals are received (e.g., after the target cell connection has been activated, and before the source is released). The WTRU may deactivate CSI-RS measurements, for example, when a best SSB changes, or when an SSB or CSI-RS measurement goes below a threshold.

In order to enable the network to adjust the timing a subset of downlink (e.g. PDCCH, PDSCH) and/or uplink resources (e.g., PUCCH, physical uplink shared channel (PUSCH)) on the source cell to align to a target/candidate cell for handover, or for the network to adjust the timing a subset of downlink and/or uplink resources on the target cell to align with the source cell, the WTRU may be configured to measure and report a timing difference measured on downlink signals between the source and target cells.

To achieve this, the WTRU may need to be able to determine a timing reference on each of the source and target cells. To derive downlink timing in NR, the WTRU may detect SSBs when performing cell search. During the initial cell search, the WTRU may scan the frequency band using the sync raster according to the frequency band the search is being performed on as per TS 38.101 [7] section 5.4.3.3—the subcarrier spacing and sync raster depends on the frequency band. The synchronization raster may indicate the frequency positions of the SSBs that can be used by the WTRU for system acquisition.

Applying synchronization algorithms using the PSS and SSS, the WTRU may estimate and correct the time and frequency offsets. The WTRU may obtain N (2) ID from PSS and then N (1) ID from SSS to determine the cell ID. With the cell ID, the WTRU may perform PBCH DMRS search in order to perform channel and noise estimation, and then demodulate and decode the PBCH to extract the remaining information needed to proceed to PDCCH monitoring for System Information Block 1 (SIB1) reception.

Once in RRC_CONNECTED, the WTRU may be configured to measure/monitor SSBs belonging to the current (e.g., source) and one or more candidate (e.g., target) cells. By deriving the timing information for both the source cell and the target cell, the WTRU may determine the relative timing between the cells.

Similar downlink synchronization signals may be necessary in future mobile communication systems. As a general rule, a WTRU may need to receive information in a downlink reference signal, such as a training sequence or reference sequence, from which a timing reference can be derived. Synchronization signals may include further information, such as an identifier of the cell, TRP, or beam (e.g., PCI, SSB index, for example), or an indication of whether the synchronization signal relates to one or more resources which use a fixed timing or a variable timing,

Once the WTRU has determined the relative timing between the source cell and a target cell, the WTRU may report this to the network using control signalling. For example, the WTRU may include the timing information in a measurement report contained in a MAC CE, in CSI report information on PUCCH, and so on. The timing information may be transmitted periodically, upon request, or upon meeting a criteria (e.g., any of the execution triggers as listed previously).

A criteria may be used for reporting the timing measurements, based on the timing measurements themselves. For example, conditions may include: (i) timing difference between source and target cells is less than a threshold (or equal to 0), (ii) timing difference between the source and a first target cell is less than the timing difference between the source and a second target cell, (iii) timing difference between source and target cells is above a threshold, (iv) timing difference between source and target cells has changed by more/less than a threshold within a given time, (v) or timing difference condition may be combined with a radio quality condition, such that both the timing condition and the radio condition should be met before a report is triggered.

During an LTM dual connection phase, several procedure options may be possible. This phase may enable the WTRU to receive and transmit using physical resources from more than one cell or TRP simultaneously (similar to a dual connection) but with the scheduling and control being performed by only one of the multiple cells, and the upper layers being associated with only one cell, rather than maintaining multiple MAC, RLC, PDCP, RRC associated with more than one cell. When the timing has been aligned, both the source cell and the target cell may be capable of scheduling resources from both the source cell and the target cell and by co-coordinating the downlink and uplink transmissions from each of the cells using a single scheduling entity, the WTRU may be reconfigured from one cell to another while both physical layer connections are available.

The WTRU may perform additional steps while both physical layer connections are available. For example, the WTRU may be triggered to perform CSI acquisition, beam refinement, or other LTM preparation steps, in order to ensure a high enough MCS and throughput can be achieved on the target cell before the source cell is released, with the benefit of not only achieving 0 ms interruption when the cell switches, but also minimizing or eliminating any throughput degradation during the mobility procedure while ensuring limited complexity in the device due to use of a single upper layer configuration at any point in time.

A trigger to perform addition of a new cell may indicate a L1 change only. A separate trigger may be used to change the upper layer configuration. For example, the WTRU may first receive a PDCCH from a first cell indicating data (e.g., PDSCH) resources on a second cell. The WTRU may receive an indication (e.g., PDCCH or MAC CE) to start monitoring PDCCH on a second cell. The WTRU may or may not apply an upper layer configuration for the second cell (so for example, the first cell may continue to handle upper layer protocols such as MAC, RLC, PDCP, RRC while the second cell performs scheduling at Layer 1).

Alternatively, the first cell may first ensure that sufficient preparation is performed on the second cell before indicating to the WTRU to monitor PDCCH on the second cell, for example by performing CSI acquisition, beam refinement, and other LTM preparation steps. On condition that the first cell indicates (e.g., using a MAC CE or PDCCH indication) to the WTRU to perform PDCCH monitoring on the second cell, the WTRU may also apply the upper layer configuration for the second cell.

The WTRU may receive an explicit signal to change the upper layer configuration (e.g., using a MAC CE or PDCCH indication), or this may occur as part of any of the steps described herein, for example, when PDCCH monitoring on the second cell starts, or when the first cell is released, upon receiving an explicit command from the network, upon detecting a certain condition is met, or at any time during the “LTM dual connection” phase indicated in FIG. 4

As a generalization, the WTRU may be first configured to receive physical layer signals from both the first and the second cell such that data reception and/or transmission may start on the second cell while the upper layer connection and scheduling is still being maintained by the first cell. Then the lower layer (e.g., the scheduling) may switch to the second cell while the upper layer connection is still maintained by the first cell. The upper layer may be reconfigured at a time when it has been ensured that communication on the second cell is sufficient (e.g., high enough MCS, beam refinement completed, good enough CSI report, LTM preparation steps are complete, etc) to maintain a high level of throughput when the upper layer configuration changes to the second cell and the first cell connection may be released (for example using a PDCCH or MAC CE indication). In various embodiments, all or part of the upper layer may be connected to both cells simultaneously, for example, in various embodiments, part of MAC may be configured separately for each cell (e.g., HARQ processes corresponding to different cells, while RLC or PDCP entities are common for both cells)

In some potential designs, the presence of a “cell” may be hidden from the WTRU. For example, a network may adapt all of part of its configuration to the configuration the WTRU may have been provided with. Or individual beams may be configured to the WTRU without the WTRU needing to have visibility of the physical location of those beams. By enabling large scale coordination of TRPs, a WTRU may experience cell centre-like data transmission and reception across the network. For moving WTRUs, serving TRPs may be dynamically selected and may be enabled without indicating a cell switch to the WTRU (e.g., the network may adapt to the WTRU configuration). In some cases, different TRPs within a “hyper-cell” may transmit identical downlink synchronization signals, or transmit using a single resource configuration. The WTRU may be configured to measure “resources” in the downlink or transmit using “resources” in the uplink, which are common to more than one TRP and which the WTRU does not need to know the physical location of the signals. In this case, an uplink sounding reference signal (SRS) may be needed for the network to determine the best uplink (for example, some scenarios such as uplink-only TRP may require this). In various embodiments, different physical layer identities may be used (e.g., PCI or another reference signal) in order for the WTRU to be able to distinguish between different TRPs, for example for the purpose of timing difference measurements.

“SRS” refers to sounding reference signal, and may be a reference signal transmitted by a WTRU in an uplink. This may be used by the network (e.g., gNB) to estimate the uplink channel quality. SRS may be used to provide information to the network about multipath fading, scattering, Doppler, and power loss of the transmitted signal. Sounding reference signals are uplink physical signals employed by user equipment (UE) for uplink channel sounding, including channel quality estimation and synchronization. Unlike demodulation reference signals (DM-RS), SRS is not associated with any physical uplink channels and they support uplink channel-dependent scheduling and link adaptation. SRS may assist with codebook-based closed-loop spatial multiplexing, control uplink transmit timing, reciprocity-based downlink precoding in multi-user MIMO setups, quasi co-location of physical channels and reference signals.

The network may perform measurements on WTRUs transmitted SRS on one or multiple TRPs. In various embodiments, the WTRU may select SRS resources for the TRPs which provide the best measured downlink beams. The WTRU may transmit using more than one SRS resource representing multiple potential target TRPs. The WTRU may include an indication of a downlink measurement value (e.g., RSRP). The WTRU may include an indication of only the downlink measurement associated with the SRS resource selection, or may include an indication of multiple downlink measurements (e.g., the best N beams).

A network may perform uplink measurements on one or more TRPs. The network may co-ordinate measurements, for example by exchanging measurement information between network node or with a central node. The network may determine, based on the measurement coordination, to select a new TRP or cell for the WTRU. In various embodiments, a WTRU may transmit uplink SRS to only one TRP and may include downlink measurements. The network may need to coordinate (e.g., only) between the target and source TRP, rather than the multiple potential targets.

In various embodiments, the network may determine, based on measuring SRS resource set transmissions (e.g. uplink beam sweep) using resources determined by the WTRU based on downlink measurements, a best fine beam to configure the WTRU with upon cell or TRP change.

In various embodiments, an intermediate node (e.g., a relay) may be employed to act as a network node. The intermediate node may perform measurements of the WTRU transmitted uplink SRS and convey measurements to a traditional (e.g., fixed TRP) network node.

In various embodiments, a network node may be configured to operate as an uplink only TRP.

In various embodiments, a network node may be deployed on an arial vehicle (e.g., drone) or on a satellite (e.g., non terrestrial network (NTN) cell)

A cell switch command may be received in a downlink signal such as DCI, MAC CE. A cell switch command may be received from a source cell (e.g., like NR) or from a target cell (e.g., a cell determined to be the best cell). In various embodiments, for example when “hyper cell” is used, the cell may be switched without notifying the WTRU, but rather the network may configure, based on uplink measurements, to use a new TRP with the same configuration as the previous one.

In various embodiments, an uplink and a downlink connection may be separately managed. For example, mobility based on reported downlink measurements may be used to manage downlink channels and TRPs, while the network may select uplink channels and TRPs based on uplink measurement signals.

In various embodiments, a cell switch command may be used to add a target cell to WTRUs connection configuration or to release a source cell from the WTRUs connection configuration. A WTRU may not switch from one cell to another, but rather may add a new cell before releasing the previous cell. Different layers of a cell may be added or released at different times, and using different triggers. For example, the physical layer of a cell may be added or released at a separate time than upper layers.

The following embodiment may refer to a L1/2 based DAPs-like procedure, but without requiring WTRU to maintain multiple “protocol stacks”. The following embodiment may refer to a make-before-break handover method performed by L1/2 triggering, based on LTM, enabled by the network adapting the uplink/downlink timing for the source and target cells such that the timing may be the same from the WTRU point of view. During a handover, the target and/or source cell may provide dedicated resources on a “synchronization” carrier or BWP, with DL and UL timing adjusted to the WTRU such that source and target DL timing appears the same to the WTRU (either the target or source or both can adjust the DL timing). The WTRU may report the time difference between the source and target resources, to enable NW to adjust the timing. The WTRU may perform CSI acquisition, beam refinement, for the target cell resources according to the aligned cell timing. The WTRU may be scheduled with resources on the target cell synchronization carrier, by the source, until throughput reaches a target amount, then the scheduling can be switched to the target and finally the source cell can be released.

Referring to FIG. 4, in an embodiment, at step 1, the WTRU may receive (e.g., and storc) a handover configuration for one or more candidate cells (e.g., like LTM). The HO configuration may include measurement RS containing a timing reference (e.g. like SSB). The HO configuration may include a subset of downlink measurement RS on the target for which to use for determining downlink reception time difference between source and target RSs. The HO configuration may include a subset of downlink measurement RS on the source for which to use for determining downlink reception time difference between source and target RSs.

The configured subset of source and target RSs may enable the embodiment to be applicable to either source cell and/or target cell doing the timing adjustment.

At step 2a, the WTRU may measure the radio/signal quality using resources on source cell and target cell.

At step 3a, the WTRU may measure a time difference between the subset of resources on source cell and target cell.

Accordingly, referring to step 2b, in case of a first condition is met, the WTRU may transmit, to the source cell (e.g., to the network), a first report of the measurement RSs belonging to the target cell (according to the configuration) that may include a report of the measured time difference between configured subset of source cell RSs and configured subset of target cell RSs. This is to allow the target cell to adjust the timing accordingly. The first condition may be based on signal quality measurement. For example, the target cell RSs meet a threshold measurement, etc. (e.g. R19 LTM events). Transmitting the report may be event triggered. For example, a single LTM MAC CE report may contain indication that the first condition is met. For example, a single LTM MAC CE report may contain indication of a source/target time difference. As another example, the WTRU may transmit an uplink control information (UCI) report (send PUCCH to request reporting resource, sent report including a source/target time difference). The report may be periodic, e.g., CSI reporting including a source/target time difference. The NW may either adjust DL timing of the source cell resources or the target cell resources.

Referring to step 3b, on condition that a second condition is met, the WTRU may transmit, to the source cell (e.g., to the network), a second report of the measurement RSs belonging to the target cell (according to the configuration) that may include a report of the measured time difference between configured subset of source cell RSs and configured subset of target cell RSs. The second condition may be based on a time difference condition, e.g., timing between source cell and sync carrier is aligned (0 or within a threshold amount from 0). Transmitting the report may be event triggered. For example, a single LTM MAC CE report may contain indication that the first condition is met, and may contain information of a source/target time difference. As another example, the WTRU may transmit an UCI report (send PUCCH to request reporting resource, sent report including a source/target time difference.) Transmitting the report may be periodic, e.g., CSI reporting including a source/target time difference. In some cases, the first and second conditions might be met simultaneously. For example, timing may be already aligned when the radio conditions meet criteria.

At step 4, the WTRU may perform CSI acquisition, beam refinement procedures for the target cell in order to enable MCS and Rx beam to be set accordingly. The WTRU may perform UL/DL synchronization, beam refinement, etc., This step may occur while the WTRU communicates with more than one cell (next steps: step 5, step 6 and step 7). Timing is aligned, such that the WTRU may perform the other preparation steps to ensure smooth cell change with minimal throughput degradation).

At step 5, the WTRU may receive a PDCCH from the source cell, which comprise information indicating PDSCH/PUSCH data resources on the target cell. The WTRU may perform reception and/or transmission using the indicated resources on the target cell, according to the handover configuration. For example, the TWRU may receive PDCCH scheduling resources on the target cell. Source cell is in control of scheduling target cell-starts the data transfer on target.

At step 6, the WTRU may receive an indication on PDCCH (or MAC CE) from the source cell to start monitoring PDCCH on the target cell. (switch L1 to target). The WTRU may receive PDCCH on the target cell—this schedules DL and UL on PDSCH/PUSCH according to the handover configuration. In other words, the WTRU may receive indication to perform PDCCH monitoring on the target cell. Target cell is in control of scheduling itself-starts the data transfer on target. If the target cell adjusted timing after step 2, then a step is needed so that the target cell may align resources to its own default timing by sending timing adjustments to the WTRU.

At step 7, the WTRU may receive an indication on PDCCH (or MAC CE) from the target cell to release configuration associated with the source cell. In other words, the WTRU may receive indication to release the source cell. Cell change is completed. The WTRU may release source cell resources and potentially update the current serving cell (e.g. RRC procedure) to be the new cell.

Benefits of the embodiments described above and illustrated at FIG. 4 may be enabling 0 ms handover interruption without temporarily maintaining two connections at higher layers, significantly simplifying WTRU behavior compared to DAPS. Enabling throughput to be maintained at a high level during and following the cell switch, significantly improving performance compared to DAPS and other mobility mechanisms.

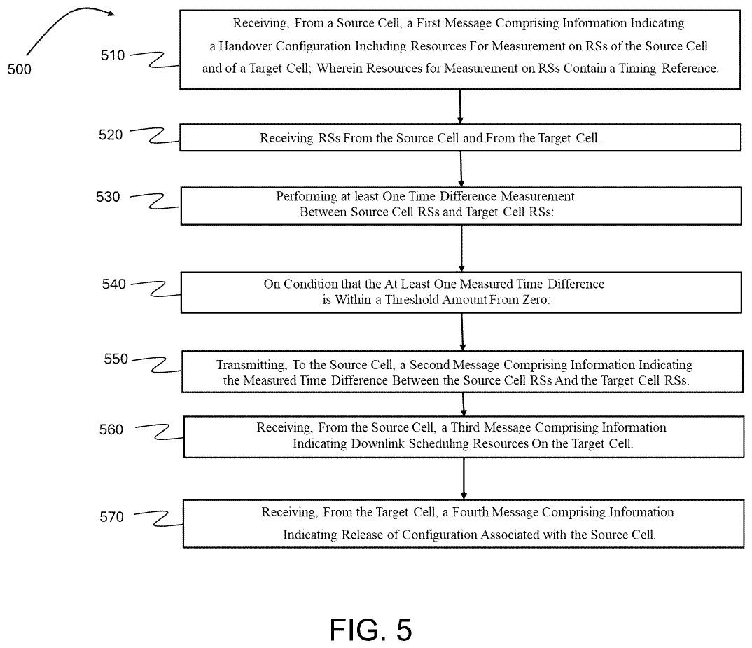

Referring to FIG. 5, a method, implemented in a wireless transmit/receive unit (WTRU), for an LTM cell switch using on downlink timing alignment may comprise a step wherein the WTRU may receive 510, from a source cell, a first message comprising information indicating a handover configuration including resources for measurement on reference signals (RSs) of the source cell and of a target cell; wherein resources for measurement on RSs contain a timing reference. The method 500 may comprise a step wherein the WTRU may receive 520 RSs from the source cell and from the target cell. The method 500 may comprise a step wherein the WTRU may perform 530 at least one time difference measurement between source cell RSs and target cell RSs. On condition that the at least one measured time difference is within a threshold amount from zero, the method 500 may comprise a step wherein the WTRU may transmit 550, to the source cell, a second message comprising information indicating the measured time difference between the source cell RSs and the target cell RSs, a step wherein the WTRU may receive 560, from the source cell, a third message comprising information indicating downlink scheduling resources on the target cell, and a step wherein the WTRU may receive 570, from the target cell, a fourth message comprising information indicating release of configuration associated with the source cell. The second message may be a channel state information or MAC CE.

The method 500 may further comprise a step wherein the WTRU may perform at least one radio quality measurement on at least one target cell RS, wherein transmitting, to the source cell, the second message is on condition that the radio quality measurement satisfies a radio quality condition threshold. The second message may further comprise information indicating result of the at least one radio quality measurement.

On condition that the at least one measured time difference is out of (e.g., above) a threshold amount from zero, the method 500 may comprise a step of transmitting, to the source cell, a fifth message comprising information indicating the measured time difference between the source cell RSs and the target cell RSs; and a step of re-performing at least one time difference measurement between source cell RSs and target cell RSs.

On condition that the at least one measured time difference is within the threshold amount from zero, the method 500 may comprise a step of performing channel state information CSI acquisition for the target cell resources according to the measured time difference.

On condition that the at least one measured time difference is within the threshold amount from zero, the method 500 may comprise a step of performing, beam refinement, for the target cell resources according to the measured time difference.

The handover configuration may include a subset of downlink measurement RS on the target for which to use for determining downlink reception time difference between source and target RSs, and/or wherein the handover configuration includes a subset of downlink measurement RS on the source for which to use for determining downlink reception time difference between source and target RSs.

The fourth message may be an indication on physical downlink control channel (PDCCH) from the target cell to release configuration associated with the source cell. The method 500 may further comprise a step of receiving an indication on PDCCH from the source cell to start monitoring the PDCCH on the target cell.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency trade-offs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, [[6 or means-plus-function claim format, and any claim without the terms “means for” is not so intended.

1. A method implemented in a wireless transmit/receive unit (WTRU) comprising:
receiving, from a source cell, a first message comprising information indicating a handover configuration including resources for measurement on reference signals (RSs) of the source cell and of a target cell; wherein resources for measurement on RSs contain a timing reference;
receiving RSs from the source cell and from the target cell;
performing at least one time difference measurement between source cell RSs and target cell RSs;
on condition that the at least one measured time difference is within a threshold amount from zero:
transmitting, to the source cell, a second message comprising information indicating the measured time difference between the source cell RSs and the target cell RSs;
receiving, from the source cell, a third message comprising information indicating downlink scheduling resources on the target cell; and
receiving, from the target cell, a fourth message comprising information indicating release of configuration associated with the source cell.

2. The method of claim 1 comprising:
performing at least one radio quality measurement on at least one target cell RS;
wherein transmitting, to the source cell, the second message is on condition that the radio quality measurement satisfies a radio quality condition threshold.

3. The method of claim 2, wherein the second message further comprises information indicating result of the at least one radio quality measurement.

4. The method of claim 1 comprising
on condition that the at least one measured time difference is above a threshold amount from zero:
transmitting, to the source cell, a fifth message comprising information indicating the measured time difference between the source cell RSs and the target cell RSs; and
re-performing at least one time difference measurement between source cell RSs and target cell RSs.

5. The method of claim 1 comprising
on condition that the at least one measured time difference is within the threshold amount from zero:
performing channel state information CSI acquisition for the target cell resources according to the measured time difference.

6. The method of claim 1 comprising
on condition that the at least one measured time difference is within the threshold amount from zero:
performing, beam refinement, for the target cell resources according to the measured time difference.

7. The method of claim 1, wherein the handover configuration includes a subset of downlink measurement RS on the target for which to use for determining downlink reception time difference between source and target RSs, and/or wherein the handover configuration includes a subset of downlink measurement RS on the source for which to use for determining downlink reception time difference between source and target RSs.

8. The method of claim 1, wherein the fourth message is an indication on physical downlink control channel (PDCCH) from the target cell to release configuration associated with the source cell.

9. The method of claim 7, comprising receiving an indication on PDCCH from the source cell to start monitoring the PDCCH on the target cell.

10. The method of claim 1, wherein the second message is a CSI or MAC CE.

11. A wireless transmit/receive unit (WTRU) comprising a processor, a transmitter, a receiver and a memory, configured to:
receive, from a source cell, a first message comprising information indicating a handover configuration including resources for measurement on reference signals (RSs) of the source cell and of a target cell; wherein resources for measurement on RSs contain a timing reference;
receive RSs from the source cell and from the target cell;
perform at least one time difference measurement between source cell RSs and target cell RSs;
on condition that the at least one measured time difference is within a threshold amount from zero:
transmit, to the source cell, a second message comprising information indicating the measured time difference between the source cell RSs and the target cell RSs;
receive, from the source cell, a third message comprising information indicating downlink scheduling resources on the target cell; and
receive, from the target cell, a fourth message comprising information indicating release of configuration associated with the source cell.

12. The WTRU of claim 11 configured to:
perform at least one radio quality measurement on at least one target cell RS;
on condition that the radio quality measurement satisfies a radio quality condition threshold, transmit, to the source cell, the second message.

13. The WTRU of claim 12, wherein the second message further comprises information indicating result of the at least one radio quality measurement.

14. The WTRU of claim 11 configured to:
on condition that the at least one measured time difference is above a threshold amount from zero:
transmit, to the source cell, a fifth message comprising information indicating the measured time difference between the source cell RSs and the target cell RSs; and
re-perform at least one time difference measurement between source cell RSs and target cell RSs.

15. The WTRU of claim 11 configured to:
on condition that the at least one measured time difference is within the threshold amount from zero:
perform channel state information CSI acquisition for the target cell resources according to the measured time difference.

16. The WTRU of claim 11 configured to:
on condition that the at least one measured time difference is within the threshold amount from zero:
perform, beam refinement, for the target cell resources according to the measured time difference.

17. The WTRU of claim 11, wherein the handover configuration includes a subset of downlink measurement RS on the target for which to use for determining downlink reception time difference between source and target RSs, and/or wherein the handover configuration includes a subset of downlink measurement RS on the source for which to use for determining downlink reception time difference between source and target RSs.

18. The WTRU of claim 11, wherein the fourth message is an indication on physical downlink control channel (PDCCH) from the target cell to release configuration associated with the source cell.

19. The WTRU of claim 18, configured to receive an indication on PDCCH from the source cell to start monitoring the PDCCH on the target cell.

20. The WTRU of claim 11, wherein the second message is a CSI or MAC CE.
